(19) United States
(12) Patent Application Publication
(10) Pub. No.: US 2009/0327064 A1
(43) Pub. Date: Dec. 31, 2009

(54) METHOD FOR SELLING BUNDLE DISCOUNT PRODUCTS IN THE ELECTRONIC COMMERCE AND COMPUTER-READABLE RECORD MEDIUM WHICH IS RECORDING A PROGRAM OF EXECUTING THE METHOD

(75) Inventor: Young Bae KU, Seocho-Gu (KR)

Correspondence Address: SCHMEISER, OLSEN & WATTS, 22 CENTURY HILL DRIVE, SUITE 302, LATHAM, NY, 12110, US

(73) Assignee: GMARKET INC., SEOUL (KR)

(21) Appl. No.: 12/488,623

(22) Filed: Jun. 22, 2009

(30) Foreign Application Priority Data
Jun. 26, 2008 (KR) 2008-0061036

(51) Int. Cl. G06Q 30/00; G06F 17/30

(52) U.S. Cl. 705/14.23; 707/104.1; 707/E17.044

(57) ABSTRACT

A method for selling bundle discount products in the electronic commerce and computer-readable record medium which is recording a program of executing the method are provided. For a plurality of bundle discount products registered by a seller or a shopping mall operator, a certain discount rate or discount price is applied and it is reflected on the final product selling price, so that a purchaser can buy a plurality of cheaper goods and a seller induces a buyer to buy large products.

### BACKGROUND OF THE INVENTION

1. Field of the Invention

The present invention relates to an electronic commerce method using the internet, and, more particularly, to an electronic commerce method using the internet which are constructed such that, for a plurality of bundle discount products registered by a seller or a shopping mall operator, a certain discount rate or discount price is applied and it is reflected on the final product selling price, so that a purchaser can buy a plurality of cheaper goods and a seller induces a buyer to buy large products.

2. Discussion of Related Art

Nowadays, the portion of an electronic commerce which purchases products at an on-line market is increasing day by day according to a rapid development of the Internet. This electronic commerce expands into various goods, including articles for daily use, household goods, electronic products, etc.

This electronic commerce results from a development of communication networks. Further, sellers and purchasers benefit from an electronic commerce, but these benefits can not get from a traditional commerce.

That is, sellers do not need to have large warehouse so that they can cut down expenses. Accordingly, the saved amounts can reflect to price of products. On the other hand, purchasers do not need to visit off-line stores and can do the shopping more conveniently and they can purchase cheaper products at an on-line shopping malls.

The cyber clients are requiring a payment system which they can receive various benefits based on sales performance in purchasing process of products using an electronic commerce as well as off-line commerce.

At present, an electronic commerce is generally a form that purchasers buy products using this information while sellers give various information for selling goods and services in the internet sites. In this case, the payment without bankbooks, payment with credit cards, cyber money can be used as the method of the payment.

As the other selling forms using the Internet, there are the auction which the price decides on the final sale price by the competition of buyers according to regular system after sellers set their first price, and the reverse auction which is against the auction. The reverse action is that if buyers show the price desired for goods purchase, a good who a seller requests the lowest price are sold by the competition which lowers the price between sellers. Also, there is a joint purchase that after the numbers of products are limited and the price in stages which is cheaper than the open market price is showed in advance and buyer demands are received, the transaction proceed with products of limited numbers.

But, the method of an electronic commerce payment has its limit because a seller set a price in advance and a price is computed in sellers' side regardless of purchasing volume. Accordingly, the method to inspire the purchasing desire of a buyer by discounting the price at the purchasing time is demanded.

That is, a buyer receives a discount in a traditional off-line commerce in general when bundle is purchased, rather than a buyer purchases small quantity of products.

In an electronic commerce, a buyer get mere benefits provided by each seller regarding each product but discount rates on large quantity of products as the above are not provided.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram of a system which implements a method for selling bundle discount products in the electronic commerce according to an embodiment of the present invention;

FIG. 2 is a flow chart which shows a method for selling bundle discount products in the electronic commerce according to an embodiment of the present invention;

FIG. 3a˜j is an exemplary computer display which shows a method for selling bundle discount products in the electronic commerce according to a embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

Bundle discount products are defined generally as comprised products so that a purchaser could get a discount if a purchaser buys various products or a purchaser could buy other products with a discount if a purchaser buys any products.

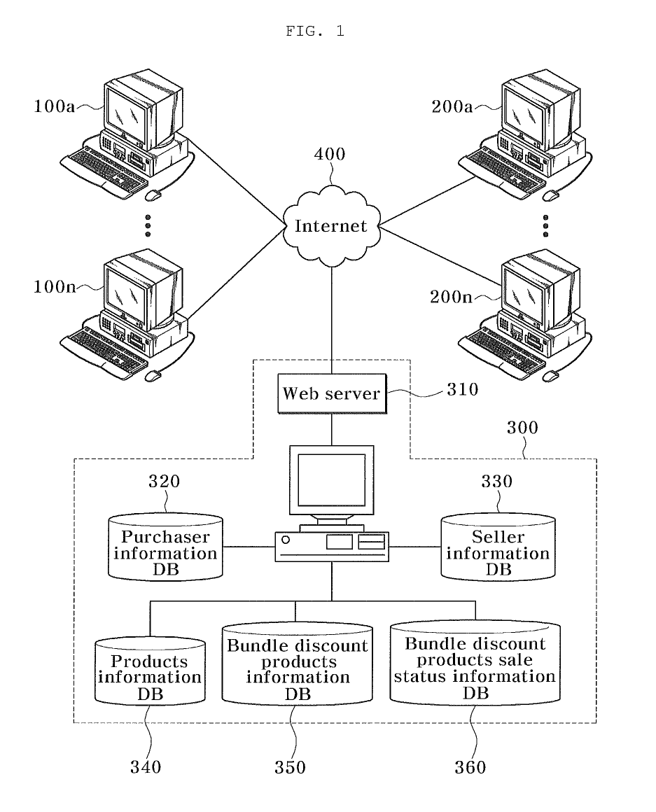

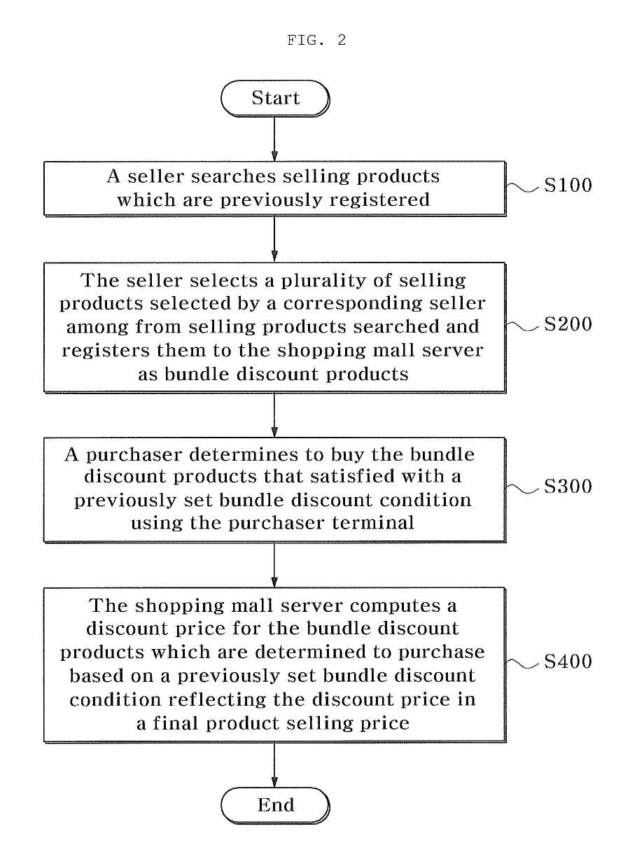

Referring to FIG. 1, an overall system of the present invention includes the purchaser terminal 100a˜100n, the seller terminals 200a˜200n, the online-in shopping mall server 300, the web server 310, the purchaser information DB 320, the seller information DB 330, the products information DB 340, the bundle discount products information DB 320 and the bundle discount products sale current status DB 360, etc.

Here, at least one of the purchaser terminals 100a˜100n and the seller terminals 200a˜200n connects to the online shopping mall server 300 via the Internet 400.

At this time, the Internet 400 means an open computer network construction which provides various services existing in TCP/IP protocol and the top level of it. Various services may be HTTP (Hyper Text Transfer Protocol), Telnet, FTP (File Transfer Protocol), DNS (Domain Name System), SMTP (Simple Mail Transfer Protocol), SNMP (Simple Network Management Protocol), NFS (Network File Service), NIS (Network Information Service) and the like.

The purchaser terminals 100a˜100n and the seller terminals 200a˜200n connect to the shopping mall server 300.

The Internet 400 may be wire or wireless Internet. Alternatively, the Internet 400 may be a core network integrated with a wired public network, a wireless mobile network, or mobile Internet.

Meanwhile, the purchaser terminals 100a˜100n and the seller terminals 200a˜200n are generally computers such as a desktop Personal Computer (PC) or a notebook PC, but are not limited thereto.

The purchaser terminals 100a˜100n and the seller terminals 200a˜200n may be any type of wired/wireless communication device capable of using a bidirectional electronic commercial service.

The purchaser terminals 100a˜100n and the seller terminals 200a˜200n include mobile terminals such as a cellular phone, a Personal Communications Services (PCS) phone, and a synchronous/asynchronous International Mobile Telecommunication-2000 (IMT-2000) phone for communicating over the wireless or mobile Internet. In addition, the purchaser terminals 100a˜100n and the seller terminals 200a˜200n comprehensively mean all wired/wireless appliance/communication devices having a user interface to access the on-line shopping mall server 300, such as a palm PC, Personal Digital Assistant (PDA), Smart phone, Wireless Application Protocol (WAP) phone, and mobile play station.

The purchaser terminals 100a˜100n can use a trading mediation service like products and services, etc furnished by the online shopping mall server 300 according to a wired/wireless communication process by communication interface.

Each purchaser can subscribe to a service of the online shopping mall server 300 as a member who is a client using services through the purchaser terminal 100a˜100n. Purchaser information registered by a purchaser who subscribed as a member is stored in the purchaser information DB 320.

Also, the seller terminals 200a˜200n can use a trading mediation service like products and services provided by the online shopping mall server 300 according to a wired/wireless communication process performed by a communication interface.

Also, each seller can subscribe to service of the online shopping mall server 300 as a member who is a client using services through the seller terminal 200a˜200n. Seller information registered by a seller who subscribed as a member is stored in the seller information DB 330.

In addition, the seller terminals 200a˜200n can access a certain website (ex. http://www.gmarket.co.kr) provided by the web server 310 and can register products which a seller tries to sell. And a seller can register a plurality of selling products selected by a corresponding seller among from selling products which are previously registered in the shopping mall server as bundle discount products based on a previously set bundle discount condition.

The seller terminals 200a˜200n accesses the web server 310 of the shopping mall server 300 and join as a member. After that, the seller terminals 200a˜200n downloads a seller management program (ex. Gmarket GSM program, etc). A seller can register selling products using this program.

Here, bundle discount condition can be applied to 1) when for all of the bundle discount products to be registered as a bundle, each bundle discount product is purchased at least one by one 2) when for a certain bundle discount product among the bundle discount products to be registered as a bundle, a predetermined price of money or more is purchased or a predetermined number or more is purchased. It is preferable that a certain discount rate or discount price is applied to all of the bundle discount products or the previously designated bundle discount product.

In addition, it is preferable that a certain bundle discount number is imparted to each bundle discount product registered as a bundle.

Further, the online shopping mall server 300 receives and registers information about various types of products handled by the seller terminals 200a˜200n through the Internet 400 and provides information about registered products to the purchaser terminals 100a˜100n through the web server 310 connected to Internet 400. The online shopping mall server 300 manages web pages for allowing a purchaser to buy a required product.

The online shopping mall server 300 can process payment for a product determined to be purchased and selected by a purchaser from a list of products for sale, and can process a delivery procedure. Specifically, the online shopping mall server 300 manages a web page available for a delivery procedure, such as by notifying the seller of the product for which payment has been completed, or a procedure, such as by tracking the position of the product being delivered or inquiring about the results of delivery, in order to deliver the product for which payment has been completed to the purchase.

Here, the on-line shopping mall server 300 brokers general sale, auction, reverse auction, negotiation, and the like for products or services between sellers and purchasers. The on-line shopping mall server 300 registers a variety of products or services of sellers received from the seller terminals 200a˜200n over the Internet 400, and provides registered products or services to the purchaser terminals 100a˜100n over the Internet 400, so that a purchaser can buy desired products or services.

Moreover, it is possible that the online shopping mall server 300 can select a plurality of selling products selected by the online shopping mall server from among selling products which are previously registered by at least one seller and can register them as bundle discount products. This case is based on a previously set bundle discount condition.

The online shopping mall server 300 can compute a discount price for the bundle discount products which are determined to purchase based on a previously set bundle discount condition, and reflect the discount price in a final product selling price when a corresponding purchaser determines to purchase the bundle discount products via the purchaser terminals 100a˜100n.

The web server 310 connects the purchaser terminal 100a˜100n and the seller terminals 200a˜200n to the online shopping mall server 300 using the Internet 400. The web server 310 provides various web services of the online shopping mall server 300 using a certain web page.

The purchasing information DB 320 is a DB for registering and managing purchaser information. The purchasing information DB 320 can read information or can be renewed with new purchaser information provided by the shopping mall server 300. For example, the purchasing information includes a buyer ID, a password, a contact address, shopping basket information, products information in a bid, products information of a successful bid, products information in a deal, products information of bundle discount products, information of products for which money has been paid, delivery information, purchase decision information, etc.

The selling information DB 330 is a DB for registering and managing seller information (ex. a seller ID, a password, a contact address, etc) and products information(ex. selling name of products, selling prices of products, brand of products, properties of products, etc.). The selling information DB 330 can read information or can be renewed with new selling information provided by the shopping mall server 300.

The products information 340, which is a DB for registering information of various products, can read information or can be renewed with new products information provided by the shopping mall server 300.

The bundle discount products information DB 350 is a DB for registering information of bundle discount products with a certain bundle discount number. The bundle discount products information DB 350 can read information or can be renewed with new bundle discount products information. A certain discount numbers are imparted by the seller terminals 200a˜200n or the online shopping mall server 300.

The bundle discount products sale status information DB 360 is a DB for registering and managing the selling status of bundle discount products which are determined to purchase using the purchaser terminals 100a˜100n. The bundle discount products sale status information DB 360 can read information or can be renewed with new selling status information provided by the shopping mall server 300.

The method for the selling bundle discount products in the electronic commerce using the internet will be described in detail below according to exemplary embodiments of the present invention.

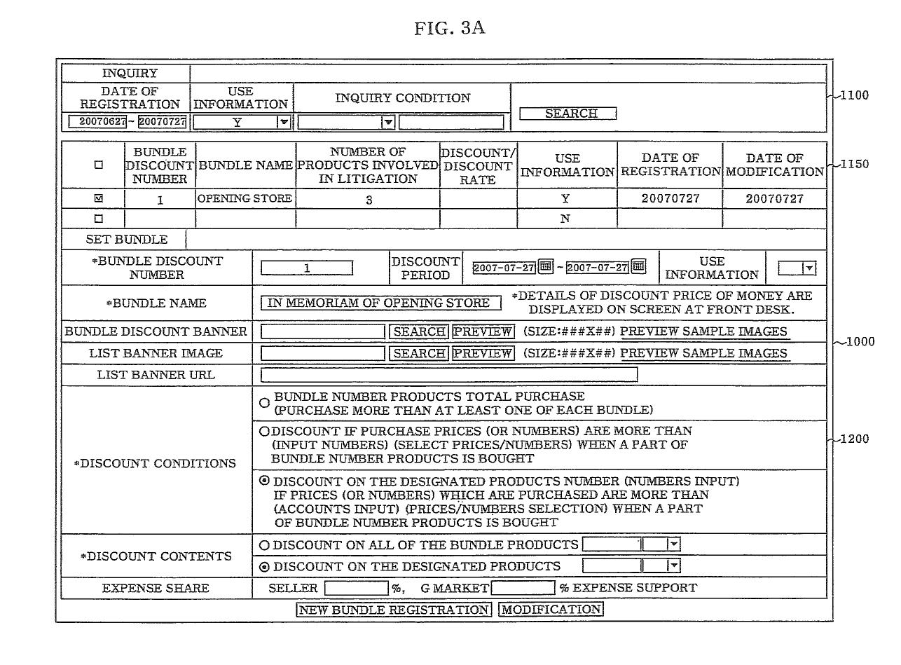

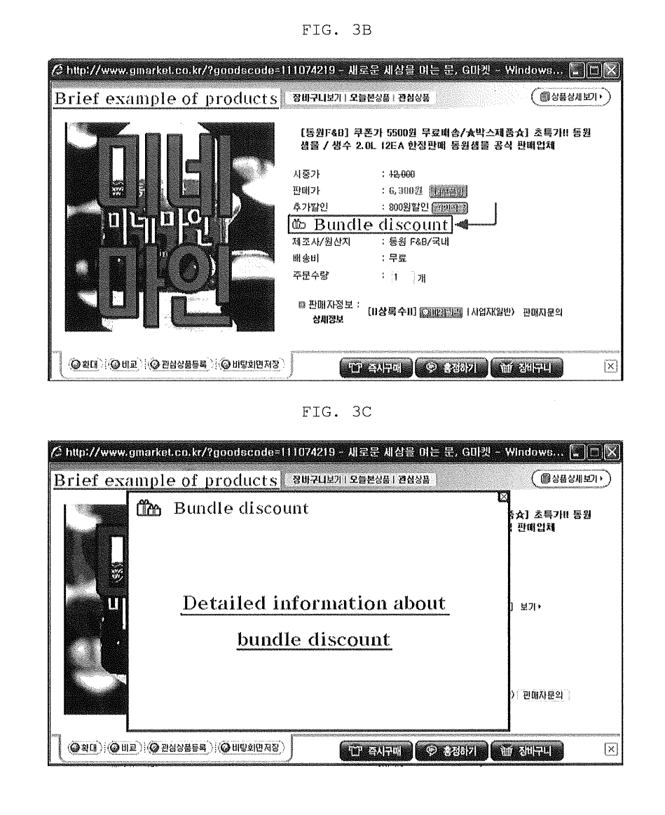

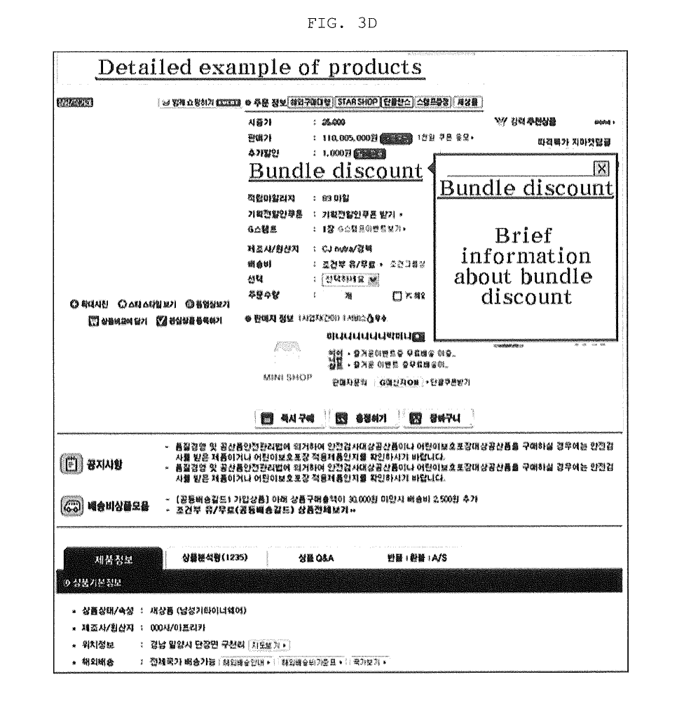

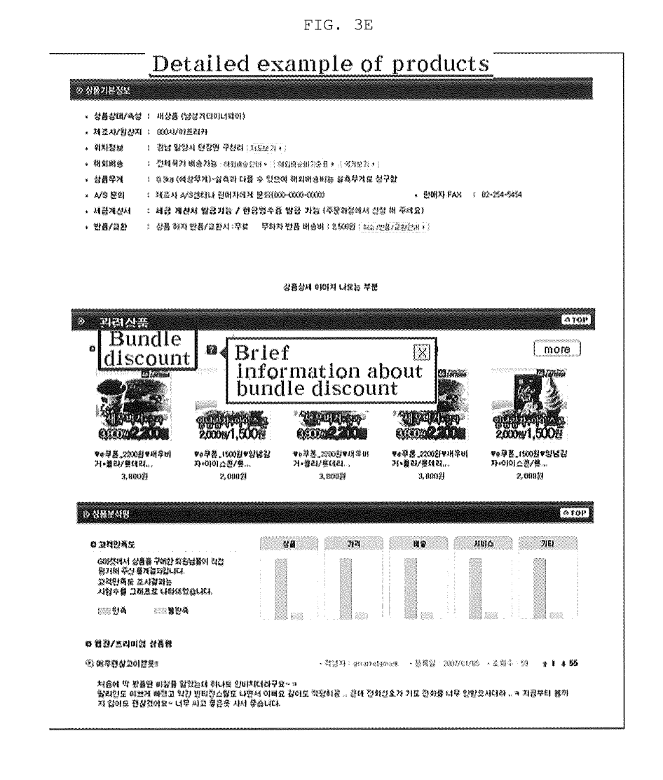

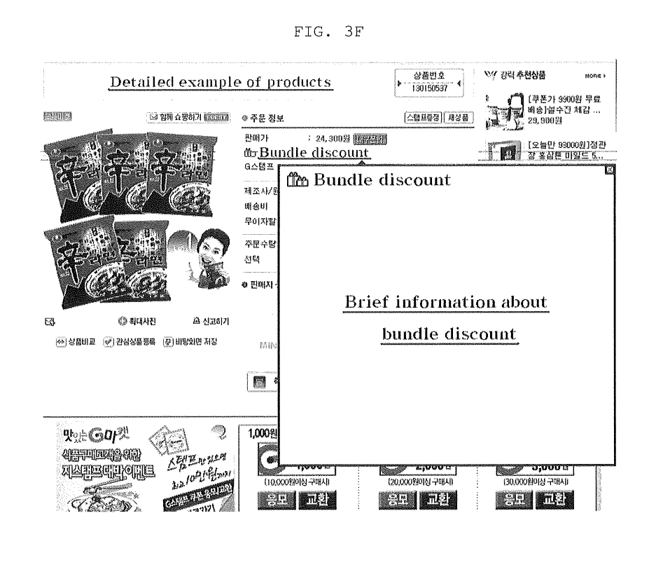

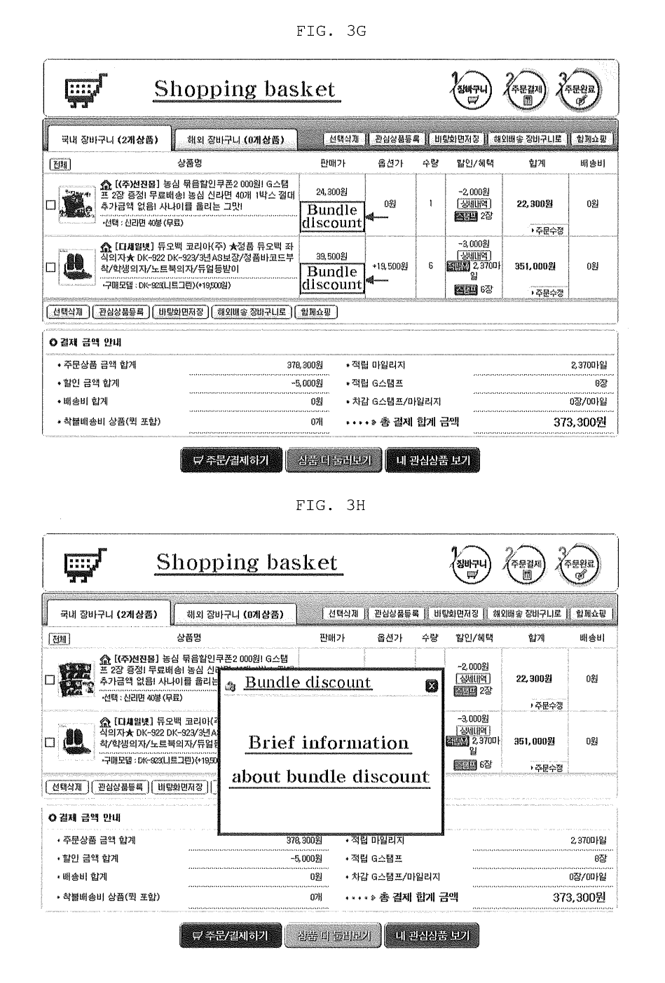

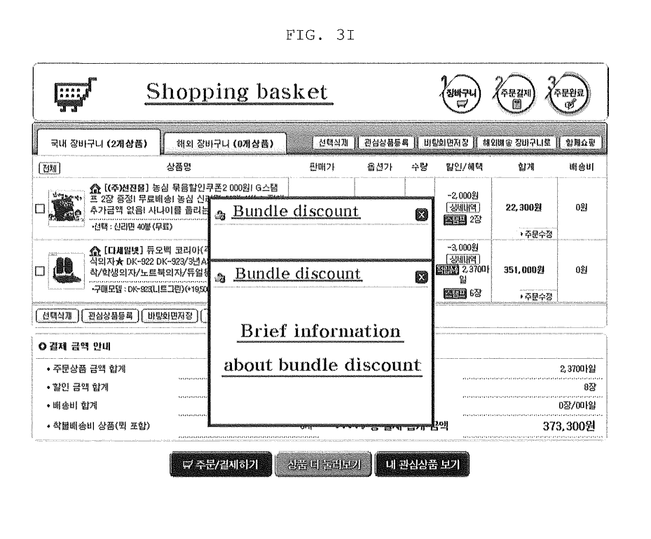

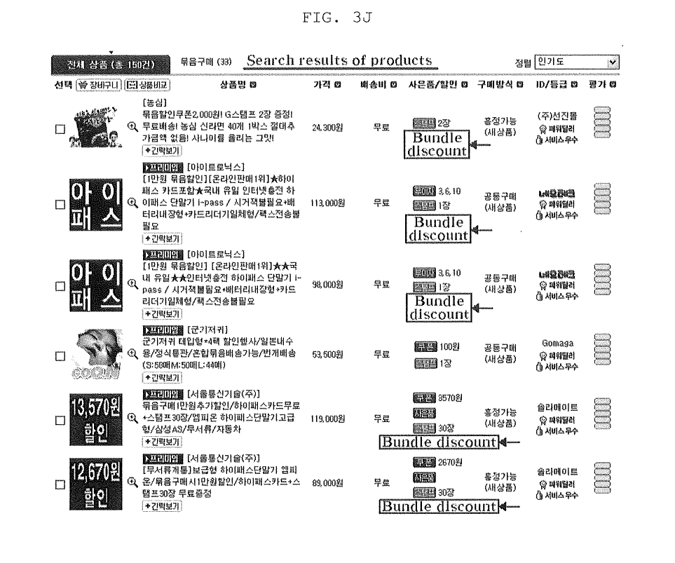

FIG. 2 is a flowchart illustrating the method for selling bundle discount products in the electronic commerce using the internet and, FIG. 3a to FIG. 3j are picture diagrams illustrating the method for selling bundle discount products in the electronic commerce using the internet. This embodiment is to explain a case which a seller registers bundle discount products. As long as any explanation is not added, it must be certainly understood that a seller management program of the seller terminals 200a˜200n performs as a subject.

Referring FIG. 1 to FIG. 3, a seller accesses the web server 310 of the shopping mall server 300 using a seller management program of the seller terminals 200a˜200n and performs log in as a member. After that, a seller searches selling products which are previously registered S100.

Next, a seller selects a plurality of selling products selected by a corresponding seller among from selling products searched in the stage S100 and registers them to the shopping mall server 300 as bundle discount products S200. At this time, a previously set bundle discount condition is used.

Here, the bundle discount condition can be applied to 1) when for all of the bundle discount products to be registered as a bundle, each bundle discount product is purchased at least one by one 2) when for a certain bundle discount product among the bundle discount products to be registered as a bundle, a predetermined price of money or more is purchased or a predetermined number or more is purchased. In these cases, it is preferable that a certain discount rate or discount price is applied to all of the bundle discount products purchased or a previously designated bundle discount product.

Specifically, FIG. 3a illustrates a configuration of a specific picture for the bundle discount products setting according to an exemplary embodiment of the present invention.

When a seller management program of the seller terminals 200a˜200n or a seller management web page of the web server 310 is operated and the menu (not shown) of the bundle discount products setting is selected(clicked). At this time, the bundle discount selection/input window 1000 is displayed in a picture of the seller terminals 200a˜200n for the search/selection of selling products which are previously registered and the bundle registration of the bundle discount.

This bundle discount selection/input window 1000 is comprised of the search/selection window 1100 for the registered products and the selection/input window 1200 for the bundle discount products registration.

The search/selection window 1100 for registered products is for searching and selecting the selling products registered by a seller within a certain period of time. This search/selection window 1100 for the registered products is provided with the fields, which are a date input room to register a date for the registered selling products, use information(total/Y/N) and inquiry condition(total/bundle discount number/bundle name) selection room and inquiry button.

Next, a process for searching the selling products which are previously registered by a seller to the shopping mall server 300 using the search/selection window 1100 for the registered products will be described. First, a seller inputs a registration date period of the selling products that a seller tries to search into the above date input room. Then, a seller selects the above use information(Y) and the previously set selection condition in inquiry condition selection room (ex. giving the basic bundle discount numbers, etc). When the inquiry button is clicked, the table forms are listed and displayed according to the bundle discount numbers based on the registered selling products within a period of the above registration date which was input in the registered products selection/mark window.

The selling products items displayed in the registered products selection/mark window are furnished with a check room for selection allowing a seller to register as bundle discount products.

Further, the selection/input window 1200 for the bundle discount products registration is furnished basically with bundle discount number input room, use information selection room, discount period selection/input room, bundle discount name input room, bundle discount banner/list manner image search room, list banner URL input room, discount condition selection/input room, discount content selection/input room, cost share rate(seller side/shopping mall operator side) input room, new bundle registration and modification button, etc.

The discount condition selection/input window is consist of selection item, ‘discount if prices(or numbers) which are purchased are more than (input numbers) (select prices/numbers) when a part of bundle number products is bought’ selection/input items' selection/input items, ‘discount on the designated products number (numbers input) if prices(or numbers) which are purchased are more than (accounts input) (prices/numbers selection) when a part of bundle number products is bought’ selection/input items.

Regarding ‘bundle number products total purchase (purchase more than at least one of each bundle)’, the bundle discount is given when at least one of each bundle is bought for all of the bundle discount products which will be registered as a bundle.

Regarding ‘discount if purchase prices(or numbers) are more than (input numbers) (select prices/numbers) when a part of bundle number products is bought’ selection/input items, the bundle discount is given when a certain number or a certain price are bought for some of bundle discount products among from bundle discount products which will be registered as a bundle.

Regarding ‘discount on the designated products number (numbers input) if prices(or numbers) which are purchased are more than (accounts input) (prices/numbers selection) when a part of bundle number products is bought’ selection/input items, the bundle discount on the designated products is given when a certain number or a certain price is bought for some of bundle discount products among from bundle discount products which will be registered as a bundle.

Further, the discount contents selection/input room is consist of ‘discount on all of the bundle products purchased (number input) (won/% selection)’ selection/input that applies a certain discount rate or a certain discount price to all of the bundle discount products purchased and, ‘discount on the designated products (number input)(won/% selection)’ selection/input items that applies a certain discount rate or a certain discount price to the designated bundle discount products.

After the above stage S200, the shopping mall server 300 controls to display the bundle discount products registered as a bundle in a certain position of a certain web page. Further, when any one of the bundle discount products among the bundle discount products which is registered as a bundle in the above stage S200 using the purchaser terminals 100a˜100n is selected, the shopping mall server 300 controls to display the rest of the bundle discount products in the detailed description of the above selected bundle discount products or in a certain position as pop-up forms.

A purchaser can take a glance at specific bundle discount contents as well as bundle discount products.

At this time, it is preferable that a certain position of the above certain web page is at least one among brief example of products(refer to FIG. 3b and FIG. 3c), detailed example of products(refer to FIG. 3d or FIG. 3f), shopping basket(refer to FIG. 3g or FIG. 3i), search results of products(refer to FIG. 3j), small reclassification of products, seller list, interest products or products comparison items.

After this, a purchaser determines to buy the bundle discount products that satisfied with a previously set bundle discount condition in the above stage S200 using the purchaser terminals 100a˜100b S300. After that, the shopping mall server 300 computes a discount price for the bundle discount products which are determined to purchase in the above stage S300 based on a previously set bundle discount condition in the above stage S200 and reflect the discount price in a final product selling price S400.

Finally, since a payment process of the bundle discount products determined to purchase after the above stage S400 is identical to an online payment process of products in an existing electronic commerce, the detailed description will be omitted.

But, when a part is canceled in shopping basket of bundle discount products with a certain bundle discount number, after checking selling condition/quantity and price condition, the case that is not an object of a bundle discount will happen. In this case, the bundle discount cancel (that is, a refund except cancel contract prices) can be happened.

At this time, when the bundle discount products which will be canceled is selected and the cancellation is proceeded, the shopping mall server 300 computes refund price and meet with minus (−) prices. The massage “in the event of canceling this bundle discount products, since an additional refund is minus, you must cancel all products.” is displayed in a screen of the purchaser terminals 100a˜100n and the next stage can not be in progress.

Meanwhile, when a shopping mall operator registers the bundle discount products, at least one of sellers searches products which are previously registered using the shopping mall server 300. After that, the seller can register a plurality of products selected by a corresponding shopping mall operator among from the registered products searched as bundle discount products in the shopping mall server 300 according to a previously set bundle discount condition.

This invention makes a buyer to purchase more things. (ex. when more than three from among a list of bundle discount products are bought, 1000 won discount on each product is given. That is, a buyer is going to buy 1˜2, but this invention can make a buyer to purchase three.)

Further, this invention can make a purchaser buy a product which purchasers avoid to buy a single purchase. Or this invention can be used as information medium of new brand products.(ex. when a purchaser buys one of the best sellers, a purchaser can take advantage of a 50% discount on new brand products.

Also, this invention can sell products, which are good if the products are purchased together, at a time.

In the mean time, the method for selling bundle discount products in the electronic commerce is possible to realize as a readable computer code which is capable of readable record medium by a computer according to embodiments of this invention. A readable computer record medium includes all kinds which store readable data by a computer system.

Furthermore, a readable computer record medium includes Rom, Ram, CD-ROM, magnetic tapes, hard disks, floppy disks, portable storing apparatus, Flash memory, optical data storing apparatus, etc. Also, it includes the forms like carrier waves (ex. transmission using the internet).

A readable computer record medium can be scattered throughout a computer system connected to a computer communication network and be store and be done as a readable code in its distributed way.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An electronic commerce method of mediating an on-line transaction between a seller and a purchaser in an on-line shopping mall through a seller terminal and a purchaser terminal which are connected to a shopping mall server via the Internet, comprising:
(a) registering a plurality of selling products selected by a corresponding seller among from selling products which are previously registered in the shopping mall server in the shopping mall server as bundle discount products through the seller terminal;
(b) by a corresponding purchaser, determining to purchase the bundle discount products through the purchaser terminal; and
(c) by the shopping mall server, computing a discount price for the bundle discount products which are determined to purchase in step (b) based on a previously set bundle discount condition, and reflecting the discount price in a final product selling price.

2. The method of claim 1, wherein in step (a), a certain bundle discount number is imparted to each bundle discount product when registering the bundle discount products as a bundle.

3. The method of claim 1, wherein in step (a), as the bundle discount condition, a certain discount rate or discount price is applied to all of the bundle discount products purchased or a previously designated bundle discount product when for all of the bundle discount products to be registered as a bundle, each bundle discount product is purchased at least one by one.

4. The method of claim 1, wherein in step (a), as the bundle discount condition, a certain discount rate or discount price is applied to all of the bundle discount products purchased or a previously designated bundle discount product when for a certain bundle discount product among the bundle discount products to be registered as a bundle, a predetermined number or more is purchased.

5. The method of claim 1, wherein in step (a), as the bundle discount condition, a certain discount rate or discount price is applied to all of the bundle discount products purchased or a previously designated bundle discount product when for a certain bundle discount product among the bundle discount products to be registered as a bundle, a predetermined price of money or more is purchased.

6. The method of claim 1, wherein in step (a), an expense share ratio between a corresponding seller and a shopping mall side for a final discount price is set when registering the bundle discount products as a bundle.

7. The method of claim 1, wherein in step (a), the shopping mall server displays the bundle discount products registered as a bundle at a certain position of a certain web page, or displays the other bundle discount products on a detailed description of a selected bundle discount product or in the form of a pup-up window at a certain position when any of the bundle discount products registered as a bundle is selected by the purchaser terminal.

8. The method of claim 1, wherein in step (c), the shopping mall server displays the details of the computed discount price of money of each bundle discount product which is determined to purchase in step (b) or (b′) in the form of a pup-up window on a certain web page.

9. The method of claim 1, further comprising, after step (c), at the shopping mall server, constructing, storing and managing a present selling situation of the bundle discount products which are determined to purchase through the purchaser terminal as a database.

10. An electronic commerce method of mediating an on-line transaction between a seller and a purchaser in an on-line shopping mall through a seller terminal and a purchaser terminal which are connected to a shopping mall server via the Internet, comprising:
(a′) registering a plurality of selling products selected by a corresponding shopping mall operator among from selling products which are previously registered by at least one seller in the shopping mall server as bundle discount products through the shopping mall server;
(b′) by a corresponding purchaser, determining to purchase the bundle discount products through the purchaser terminal; and
(c′) by the shopping mall server, computing a discount price for the bundle discount products which are determined to purchase in step (b′) based on a previously set bundle discount condition, and reflecting the discount price in a final product selling price.

11. The method of claim 10, wherein in step (a′), a certain bundle discount number is imparted to each bundle discount product when registering the bundle discount products as a bundle.

12. The method of claim 10, wherein in step (a′), as the bundle discount condition, a certain discount rate or discount price is applied to all of the bundle discount products purchased or a previously designated bundle discount product when for all of the bundle discount products to be registered as a bundle, each bundle discount product is purchased at least one by one.

13. The method of claim 10, wherein in step (a′), as the bundle discount condition, a certain discount rate or discount price is applied to all of the bundle discount products purchased or a previously designated bundle discount product when for a certain bundle discount product among the bundle discount products to be registered as a bundle, a predetermined number or more is purchased.

14. The method of claim 10, wherein in step (a′), as the bundle discount condition, a certain discount rate or discount price is applied to all of the bundle discount products purchased or a previously designated bundle discount product when for a certain bundle discount product among the bundle discount products to be registered as a bundle, a predetermined price of money or more is purchased.

15. The method of claim 10, wherein in step (a′), an expense share ratio between a corresponding seller and a shopping mall side for a final discount price is set when registering the bundle discount products as a bundle.

16. The method of claim 10, wherein after step (a′), the shopping mall server displays the bundle discount products registered as a bundle at a certain position of a certain web page, or displays the other bundle discount products on a detailed description of a selected bundle discount product or in the form of a pup-up window at a certain position when any of the bundle discount products registered as a bundle is selected by the purchaser terminal.

17. The method of claim 10, wherein in step (c′), the shopping mall server displays the details of the computed discount price of money of each bundle discount product which is determined to purchase in step (b) or (b′) in the form of a pup-up window on a certain web page.

18. The method of claim 10, further comprising, after step (c′), at the shopping mall server, constructing, storing and managing a present selling situation of the bundle discount products which are determined to purchase through the purchaser terminal as a database.
